(19) United States
(12) Patent Application Publication
(10) Pub. No.: US 2014/0188522 A1
(43) Pub. Date: Jul. 3, 2014

(54) SYSTEMS AND METHODS FOR PREDICTING THE VALUE OF PERSONAL PROPERTY

(71) Applicant: ENSERVIO, INC., Needham, MA (US)

(72) Inventor: James Fini, Needham, MA (US)

(73) Assignee: ENSERVIO, INC., Needham, MA (US)

(21) Appl. No.: 14/135,421

(22) Filed: Dec. 19, 2013

Related U.S. Application Data
(63) Continuation of application No. 13/495,635, filed on Jun. 13, 2012.
(60) Provisional application No. 61/497,689, filed on Jun. 16, 2011.

(51) Int. Cl. G06Q 40/08

(52) U.S. Cl. CPC G06Q 40/08
USPC 705/4

(57) ABSTRACT

Accurate, appropriate valuation of the contents of a residence is facilitated based on characteristics of the household and the residence. These factors are used to estimate the proper value of the contents and may be based, at least in part and in various embodiments, on information collected in the course of the insurance underwriting process and from public and non-public consumer spending data.

### CROSS-REFERENCES TO RELATED APPLICATIONS

The present application is a continuation of U.S. patent application Ser. No. 13/495,635, filed on Jun. 13, 2013, which claims benefit under 35 U.S.C. §119(e) of U.S. Provisional Patent Application No. 61/497,689, filed on Jun. 16, 2011. The disclosures of these applications are hereby incorporated by reference in their entirety for all purposes.

### TECHNICAL FIELD

Embodiments of the invention relate generally to systems and methods for property insurance underwriting and claims.

### BACKGROUND OF THE INVENTION

Consumers often purchase insurance to cover losses to real and personal property. In many cases, insurance related to a home or business may cover the physical structure (“Coverage A”) and personal property (“Coverage C”). For example, a typical homeowner's policy covers losses of items within the home, such as furniture, clothing, electronics, appliances, artwork, jewelry, kitchenware and dinnerware, and other items. Renter's and condominium owner's insurance cover many of the same items, excluding fixtures and the like.

Insurance risks in homeowner's policies are based on the costs to replace the structure and contents of a residence. The industry best practice for setting the policy amount of Coverage A is to determine the replacement cost of the structure in a total loss, and use that value as an estimate of the cost to rebuild or repair the structure to be of like kind and quality to the structure prior to a loss. This replacement cost is estimated using variables including, but not limited to, geography, square footage of structure, roof type, foundation type, floor quality, and other factors well known to those in the industry.

In setting the value of the coverage for personal property (in a home as opposed to a condominium or apartment), conventional practice is to set Coverage C as a percentage of Coverage A. This is somewhat arbitrary, however, since the variables that are used to set the value of Coverage A generally have little or no correlation with the replacement cost for Coverage C. As a result, the personal property insured by Coverage C in homeowner's insurance policies is frequently overvalued or undervalued (i.e., the policy holder is overinsured or underinsured). If a policyholder's personal property is overinsured, the policyholder is paying premiums for more coverage than is needed, and if a policyholder's personal property is underinsured, the policyholder will not have enough insurance to cover or replace the personal property in the event of an insured loss. In general, best-practice insurance underwriting requires insuring to the value (“ITV”) as closely as possible, so that the insured coverage matches the actual value of the insured property as closely as possible. As used herein, the term “policyholder” connotes both actual and prospective owners of insurance policies, and “contents” refers to personal property at an insured residence (whether subject to Coverage C or other insurance coverage).

Unfortunately, at present, if ITV for contents is pursued at all, it is typically based on a full inventory and appraisal of the policyholder's personal property—an inconvenient and costly undertaking For apartments and condominiums, the practice in setting coverage limits for personal property is even less precise. The insured may accept the recommendation, based on generic averages, of an insurance professional who may or may not have visited the insured residence. Alternatively, the insured may be called upon to make an estimate of contents value with little guidance.

### SUMMARY OF THE INVENTION

In various embodiments, the present invention relates to a system and techniques that facilitate accurate, appropriate valuation of the contents of a residence based on characteristics of the household and the residence. These factors are used to estimate the proper value of the contents and may be based, at least in part, on information collected in the course of the insurance-underwriting process and from public and non-public consumer spending data.

Implementations in accordance with the invention may take various forms. For example, the system may be maintained by an insurance company for its own internal use, or may be realized as a server-based system accessible to insurers (or policyholders) on a transactional basis. In another embodiment, the system and associated techniques and products allow insurance companies to calculate information related to their underwriting, including but not limited to premium levels, reserve requirements, and risk exposure.

The invention is not limited to insurance applications. For example, many homeowners or businesses may wish to estimate their property contents for tax or other reasons, and advertisers may use estimates of personal property owned by prospects to more effectively target ads or marketing campaigns.

Accordingly, in a first aspect, the invention pertains to a workflow system for assembling a predicted inventory of property present in a home or business. In various embodiments, the system comprises a database for storing data for a plurality of consumers or businesses; the data comprises, for each consumer or business, (i) categories of personal or business property typically found in a home or business, (ii) a geographic location of the consumer or business, and (iii) demographic characteristics of the consumer or business. The system also comprises a segregation module for accessing a bulk source of consumer or business spending data for personal property and segregating the spending data based on categories data, demographic characteristics and geographic locations. An aggregate lifetime spending determination module accesses data from the segregation module and compiles an aggregate lifetime spending amount for at least one category of property based on the segregated spending data and an amount of time since an inception date; the inception date corresponds to (i) in the case of a consumer, when the consumer became an adult, and (ii) in the case of a business, when the business began operations. A depletion module applies, to the aggregate lifetime spending amount, at least one depletion factor indicative of an average property retention duration for each category of property.

In some embodiments, the system further comprises a database of historical personal property claims across a plurality of insurance carriers. For example, the database may include, for a plurality of claims paid to policyholder claimants for each insurance carrier, (i) at least one category of claimed property, (ii) an adjusted replacement cost value (RCV) for each category of claimed property, (iii) quantities and ages of items of claimed property, (iv) depreciation applied by the carrier to items of the claimed property, (v) brands and vendors for items of the claimed property, and (vi) policy limits applied by the carrier for each claimed category of property, the depletion module accessing data from the database of historical property claims and computing the depletion factor based at least in part thereon. The database of historical property claims may have records spanning multiple insurance carriers and multiple policyholder geographies and demographies.

In another aspect, the invention relates to a workflow system for assembling an insurance product. In various embodiments, the system comprises a database for storing policyholder data for a plurality of policyholders; the policyholder data comprises, for each policyholder, (i) categories of personal property covered by an insurance policy associated with the policyholder, (ii) a geographic location of the policyholder, (iii) demographic characteristics of the policyholder, and (iv) data indicative of when the policyholder became an independent adult consumer. A segregation module accesses a bulk source of consumer spending data for personal property and segregates the spending data for each policyholder based on the categories data, the demographic characteristics and the geographic location associated with the policyholder. A coverage determination module accesses data from the segregation module and compiles an aggregate lifetime spending amount for each policyholder for at least one category of personal property based on the segregated spending data and an amount of time since the policyholder became an adult consumer. A depletion module adjusts the coverage amount by applying thereto at least one depletion factor indicative of an average property retention duration for each category of personal property.

In various embodiments, the system further comprises a database of historical personal property claims across a plurality of insurance carriers comprising, for a plurality of claims paid to policyholder claimants for each insurance carrier, (i) at least one category of claimed personal property, (ii) an adjusted replacement cost value (RCV) for each category of claimed personal property, (iii) quantities and ages of items of claimed personal property, (iv) depreciation applied by the carrier to items of the claimed personal property, (v) brands and vendors for items of the claimed personal property, and (vi) policy limits applied by the carrier for each claimed category of personal property. The depletion module accesses data from the database of historical personal property claims and computing the depletion factor based at least in part thereon. The database of historical personal property claims may comprise records spanning a plurality of insurance carriers and a plurality of policyholder geographies and demographies.

In some embodiments, the system comprises a depreciation module for adjusting the coverage amount for at least one category of personal property covered by an insurance policy associated with the policyholder by applying thereto at least one depreciation factor indicative of an average decrease in value of personal property over time for the at least one category of personal property. The policyholder data may further comprise, for each policyholder, data indicative of policyholder demographic information.

In various embodiments, the coverage determination module compiles the coverage amount in part by summing across the categories of personal property spending data based on the amount of time since the policyholder became an adult consumer. The depletion module may apply a separate depletion factor to each category of personal property; for example, the depletion factor for a category may depend on the category and/or the amount of time since the policyholder became an adult consumer and/or demographic information about the policyholder's household.

In some embodiments, the depreciation module applies a separate depreciation factor to each category of personal property, the depreciation factor for a category depending on at least one of (i) the category, (ii) an amount of time since the policyholder became an adult consumer, or (iii) demographic information about the policyholder's household. The system may also include a policy-generation module for generating an insurance policy based at least in part on the adjusted coverage amount.

In still another aspect, the invention relates to a method of assembling an insurance product based on stored policyholder data for a plurality of policyholders. The policyholder data generally comprises, for each policyholder, (i) categories of personal property covered by an insurance policy associated with the policyholder, (ii) a geographic location of the policyholder, (iii) demographic characteristics of the policyholder, and (iv) data indicative of when the policyholder became an independent adult consumer. In various embodiments, the method comprises the steps of using a computer to access a bulk source of consumer spending data for personal property; computationally segregating the spending data for each policyholder based on the categories data, the demographic characteristics and the geographic location associated with the policyholder; using the computer to compile a coverage amount for each policyholder based on the segregated spending data and an amount of time since the policyholder became an adult consumer; and computationally adjusting the coverage amount by applying thereto at least one depletion factor indicative of an average property retention duration.

The depletion factor may be computed at least in part based on data indicative of historical personal property claims across a plurality of insurance carriers, the data comprising, for a plurality of claims paid to policyholder claimants for each insurance carrier, (i) at least one category of claimed personal property, (ii) an adjusted replacement cost value (RCV) for each category of claimed personal property, (iii) quantities and ages of items of claimed personal property, (iv) depreciation applied by the carrier to items of the claimed personal property, (v) brands and vendors for items of the claimed personal property, and (vi) policy limits applied by the carrier for each claimed category of personal property. The policyholder data may further include income level, marital status, size of household, ages of household members, and/or genders of household members. In some embodiments, the bulk source of consumer spending data for personal property is the Consumer Expenditure Survey.

The average decrease in value of personal property over time can be captured by applying at least one depreciation factor to adjust the coverage amount. For insurance purposes, the method can include computing the policyholder's premium levels and/or computing a risk score for the policyholder. For example, the risk score may be calculated based a plurality on geographic and demographic risk exposure variables. The method can also include computationally generating an insurance policy based at least in part on the adjusted coverage amount, and beyond that, computing reserve requirements for an insurance company.

In still another aspect, the invention relates to a method of assembling a predicted inventory of property present in a home or business based on data for a plurality of consumers or businesses, where the data includes or consists of, for each consumer or business, (i) categories of personal or business property typically found in a home or business, (ii) a geographic location of the consumer or business, and (iii) demographic characteristics of the consumer or business. In various embodiments, the method comprises the steps of using a computer to access a bulk source of consumer or business spending data; computationally segregating the spending data based on the categories data, the demographic characteristics and the geographic locations; using the computer to determine an aggregate lifetime spending by accessing the segregated data and compiling an aggregate lifetime spending amount for at least one category of property based on the segregated spending data and an amount of time since an inception date, where the inception date corresponds to (i) in the case of a consumer, when the consumer became an adult, and (ii) in the case of a business, when the business began operations; and computationally adjusting the aggregate lifetime spending amount by applying thereto at least one depletion factor indicative of an average property retention duration for the at least one category of property.

In various embodiments, the depletion factor is computed based at least in part on data indicative of historical property claims across a plurality of insurance carriers comprising, for a plurality of claims paid to policyholder claimants for each insurance carrier, (i) at least one category of claimed property, (ii) an adjusted replacement cost value (RCV) for each category of claimed property, (iii) quantities and ages of items of claimed property, (iv) depreciation applied by the carrier to items of the claimed property, (v) brands and vendors for items of the claimed property, and (vi) policy limits applied by the carrier for each claimed category of property. The historical property claims may span a plurality of insurance carriers and a plurality of policyholder geographies and demographies.

### BRIEF DESCRIPTION OF THE DRAWINGS

The present invention is described in detail below with reference to the attached drawing, wherein:

FIG. 1 is a flow chart illustrating a method of obtaining a contents value in accordance with an embodiment of the invention; and

FIGS. 2 and 3 are block diagrams illustrating representative systems in accordance with embodiments of the invention.

### DETAILED DESCRIPTION OF SPECIFIC EMBODIMENTS

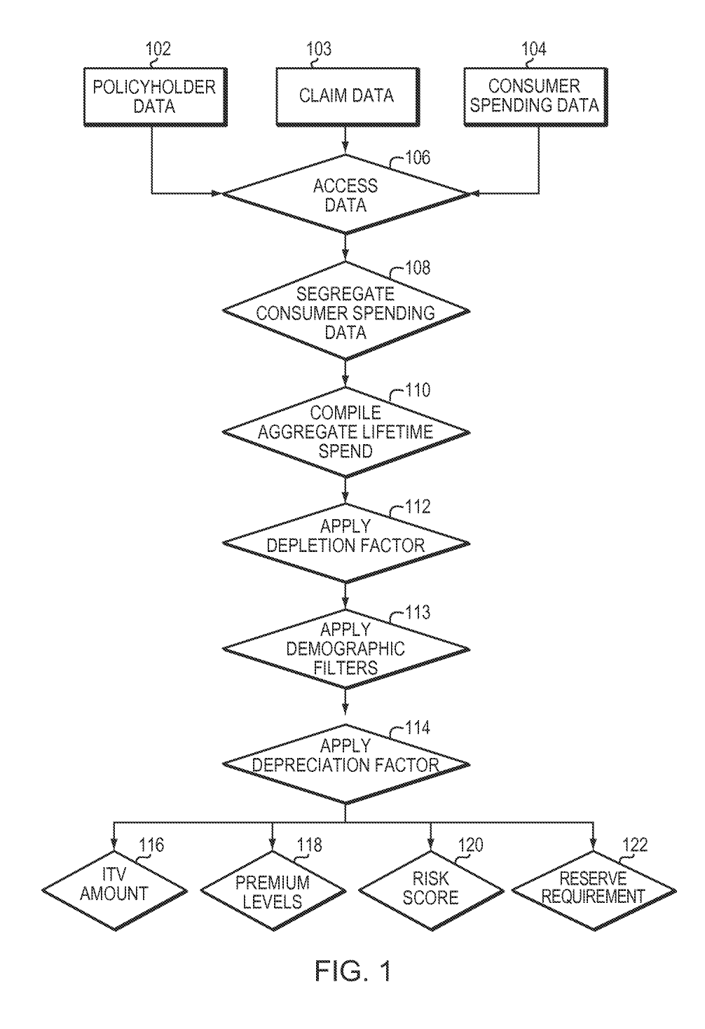

FIG. 1 illustrates the operation of a representative embodiment of the present invention. Although the embodiment involves an insurance application, this is solely for purposes of illustration, and it should be understood that the principles of the invention may be applied outside the insurance context.

Policyholder data is stored in a database 102, e.g., in the form of a database record associated with each policyholder. The policyholder data may be collected during underwriting or otherwise obtained, and may comprise, without limitation, information including categories of personal property covered by the policyholder's insurance policy, the policyholder's geographic location, and data indicative of when the policyholder became an independent adult consumer.

Claim data is stored in a database 103, e.g., in the form of a database record associated with each policyholder. Claim data includes characteristics and values associated with items of personal property that were the subject of actual claims against insurance policies. This data represents the value of personal property by product category actually present in households based on insurance claim data. As explained in greater detail below, this data may be used to calculate a depletion factor.

A bulk source of consumer spending data is also illustrated as stored in a database 104, but in fact the database is typically associated with government, academic or other professional sources specializing in this type of data and making it available, freely or by subscription, over the Internet (where it may be accessed by a computer in step 106). The bulk source of consumer spending data 104 accessed in step 106 may be public and/or non-public, and in some embodiments of the present invention, the bulk source of consumer spending data 104 may consist of or include the Consumer Expenditure Survey (“CEX”) conducted by the U.S. Bureau of Labor Statistics.

In step 106 the computer accesses the bulk source of consumer spending data, and in step 108 computationally segregates the data to extract only those categories of expenditures that are covered under the policyholder's homeowner's insurance, such as clothing, food, electronics and jewelry (and excluding other categories such as travel, movies, gasoline and cable TV). In this way, the bulk spending data is processed to include as many relevant categories of goods as possible, and to exclude as many irrelevant categories as possible. Since the ultimate objective is to provide an estimate, great precision is not necessary.

The consumer spending data may be further parsed based on characteristics common to policyholders and relevant to the value of contents, e.g., geographic location and demographic variables (such as income levels, marital status, age, gender, and size of household). If the bulk consumer spending data is or may be segregated according to such variables—e.g., in tiers each corresponding to a range, such as income levels), then the data may be further tailored to each policyholder record in the database 102 to the extent the records contain values for these variables.

In these ways, the bulk consumer spending data is filtered based on relevant characteristics of the policy and of the individual policyholder. The computer then compiles an aggregate lifetime spending amount 110 for each policyholder based on the segregated spending data and the amount of time that has elapsed since the policyholder became an adult consumer. Finally, the computer may computationally adjust the coverage amount by applying at least one depletion factor (step 112) to at least one category of insured personal property indicative of an average property retention duration. This depletion factor may be derived using historical property claim data relevant to the geographic and demographic variables.

In some embodiments, the coverage amount is further adjusted (step 113) by applying thereto at least one filtering factor which either increases or decreases a category of spending based demographic variables. For example, if the household contains no male children, all spending data related to male children is eliminated. Similarly, if there are several male children present, the factor will more heavily weight the spending data related to male children.

The coverage amount may optionally be further adjusted (step 114) by applying thereto at least one depreciation factor indicative of an average decrease in value of personal property over time. Typically the depreciation factor is applied to the cost of the insured personal property after the depletion factor, yielding the ITV amount 116. Of course, if the depreciation and depletion factors are static coefficients, or even if they vary over time and are applied as time series, their order of application should not matter. But in embodiments where the value of one or both factors depends on the compiled coverage amount to which it is applied, the order can be important. Furthermore, depending on the nature of the policy, either or both factors may be omitted. For example, depreciation may not be relevant in the context of a full replacement-cost policy.

The policyholder's premium levels 118 may be computationally calculated based on the ITV amount 116. Alternatively or in addition, a risk score 120 for the policyholder may be computationally calculated, and this score may be based on a plurality of geographic and demographic risk-exposure variables whose values are contained in databases 102 and 103. Furthermore, claim reserve requirements 122 for an insurance company may be computed, for a particular policy, based on the ITV replacement cost value (“RCV”) or the ITV actual cost value (“ACV” or actual cash value) for a given policy multiplied by a percentage factor representing an estimate by claim adjusters of the portion of the total value of personal or business property that will be the subject of a property claim.

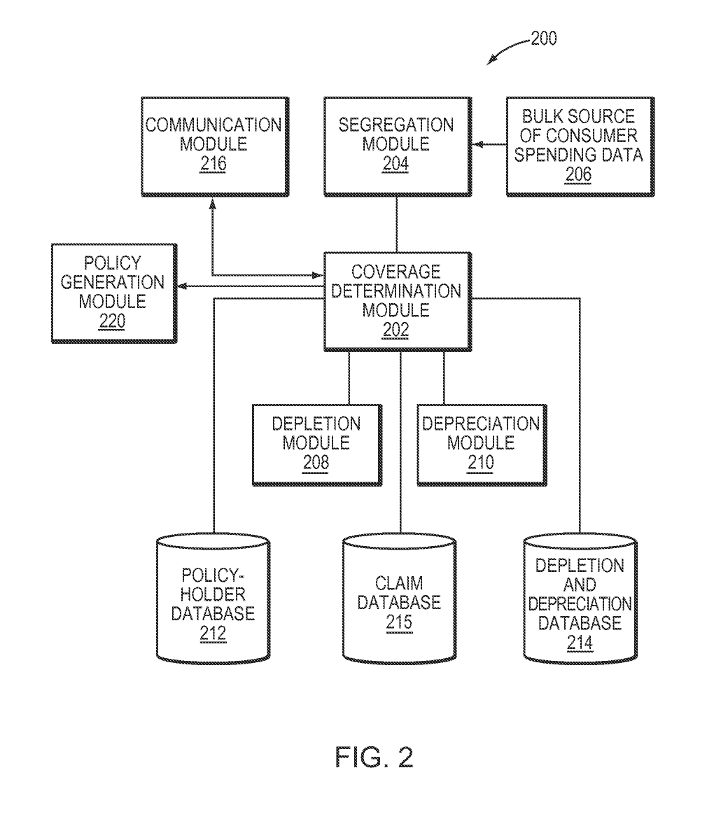

FIG. 2 illustrates a representative system 200 for implementing the techniques described above. The system is typically implemented in a central computing device, described in greater detail below, that has a central processor, memory, mass storage, input/output facilities, a display, etc., all of which are conventional and not shown in FIG. 2. A coverage determination module 202 communicates with a segregation module 204, which accesses a bulk source 206 of public and/or non-public consumer spending data by means of a conventional communication module 216, which is typically configured for communication over local and wide-area networks; for example, source 206 may be accessed via the Internet. The segregation module 204 segregates the spending data for each policyholder based on the variables discussed above. The coverage determination module 202 accesses data from the segregation module 204 and compiles a coverage amount for each policyholder based on the segregated spending data and data specific to each policyholder.

Policyholder data is stored in a policyholder database 212, which contains information collected during underwriting or otherwise obtained regarding each policyholder. Additionally, the coverage determination module 202 communicates with a depletion module 208 and a depreciation module 210, which apply depletion and depreciation factors, respectively, to coverage amounts computed by the coverage determination module 202. The depreciation factors applied by the depreciation module 210 are indicative of the decrease in value of the insured personal property over time.

The modules 208, 210 may draw upon a depletion and depreciation database 214 for depletion factors and/or depreciation factors or variable data useful in the computation thereof. The depletion and depreciation database 214 may, for example, contain depletion factors to be applied to categories of personal property, which may in turn depend on the category of personal property, the amount of time since the policyholder became an adult consumer, and/or demographic information about the policyholder's household. The depletion and depreciation database 214 may also contain depreciation factors to be applied to categories of personal property, which may depend on the category of personal property, the amount of time since the policyholder became an adult consumer, and demographic information about the policyholder's household.

For instance, some categories of insured personal property, such as children's clothing and toys, may be depleted from the insured personal property as children age, as the policyholders donate items to charity or pass them on to others. Other categories of insured personal property, such as food, may be depleted relatively quickly from the policyholder's ownership. Still other categories of insured personal property, such as clothing, jewelry, or furniture, may have much longer ownership timeframes. The application of depletion factors to the aggregate lifetime spending yields the RCV of the policyholder's personal property, and the application of depreciation factors to the RCV yields the ACV of the policyholder's personal property.

In addition, the depletion factor may be computed based also on the contents of a claim database 215, which contains records specifying historical personal property claims across a plurality of insurance carriers. The records comprise data relating to claims paid to policyholder claimants for each insurance carrier, and the data may include or consist of (i) at least one category of claimed personal property, (ii) an adjusted replacement cost value (RCV) for each category of claimed personal property, (iii) quantities and ages of items of claimed personal property, (iv) depreciation applied by the carrier to items of the claimed personal property, (v) brands and vendors for items of the claimed personal property, and (vi) policy limits applied by the carrier for each claimed category of personal property. This data is helpful to computation of a depletion factor because it reflects actual RCV data compiled in the course of claims payment. Accordingly, in some embodiments, the depletion module 210 accesses this data and computes the depletion factor based at least in part thereon. For statistical accuracy, large numbers (e.g., more than 200) of insurance carriers and larger numbers of actual claims paid (e.g., more than 10,000) across statistically varied geographies are desirable.

In alternative embodiments, the depletion and/or depreciation factors are computed more generically, e.g., based on broad statistical modeling or publicly available data, which is desirably, although not necessarily, differentiated among policyholders to reflect differing demographic characteristics. The objective, as explained above, is to model current property holdings based on historical spending estimates.

In some embodiments, a policy-generation module 220 assembles an insurance policy for a policy applicant based on the computed RCV of the applicant's personal property, the information supplied by the applicant in his or her policy application, and the criteria conventionally employed by the insurance carrier in writing homeowners' policies. The policy may be furnished to the applicant in paper and/or electronic form.

The various modules described above may be implemented by computer-executable instructions, such as program modules, executed by a conventional computer. Generally, program modules include routines, programs, objects, components, data structures, etc. that performs particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device 200 may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, an OPENSTEP operating system or another operating system of platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

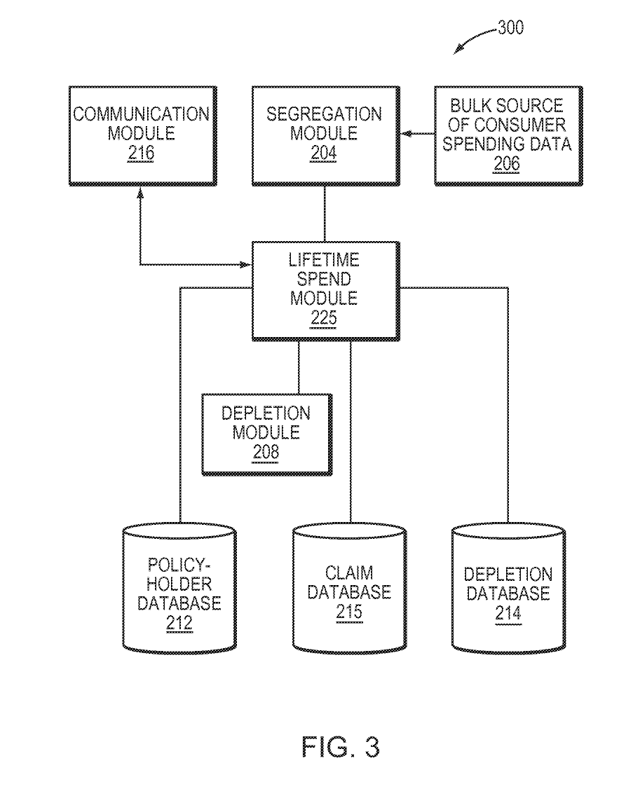

While particular embodiments of the invention have been illustrated and described in detail herein, it should be understood that various changes and modifications might be made to the invention without departing from the scope and intent of the invention. For example, embodiments of the invention may be deployed more generically as a workflow system 300 for assembling a predicted inventory of all personal property present in a home or business, as shown in FIG. 3. In this case, a bulk source of consumer or business spending data is again used, and the coverage determination module 202 is replaced with a module 225 for determining aggregate lifetime spend, which performs functions similar to that of module 202. In particular, the module 225 accesses data from the segregation module 204 and compiles an aggregate lifetime spending amount for at least one category of personal property based on the segregated spending data and an amount of time since an inception date—i.e., when a homeowner became an adult consumer or when a business began operations. The depletion module 208 applies to the aggregate lifetime spending amount at least one depletion factor indicative of an average property retention duration for the at least one category of personal property.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1.-20. (canceled)

21. A workflow system for assembling an insurance product, the system comprising:
a database for storing policyholder data for a plurality of policyholders, the policyholder data comprising, for each policyholder, categories of personal property covered by an insurance policy associated with the policyholder;
a segregation module configured to access a bulk source of consumer spending data for personal property and segregating the spending data for each policyholder based on the categories of personal property, demographic characteristics and a geographic location associated with the policyholder;
a coverage determination module configured to access data from the segregation module and compute a coverage amount for each policyholder for at least one category of personal property based on the segregated spending data and an amount of time since the policyholder became an adult consumer; and
a depletion module configured to computationally adjust the coverage amount for the at least one category of personal property associated with the policyholder by applying thereto at least one depletion factor indicative of an average property retention duration for the at least one category of personal property; and
a depreciation module configured to computationally adjust the coverage amount for the at least one category of personal property associated with the policyholder by applying thereto at least one depreciation factor indicative of an average decrease in value of personal property over time for the at least one category of personal property.

22. The system of claim 21 wherein the depreciation module is further configured to compute an insuring to value (ITV) amount for the at least one category of personal property associated with the policyholder based at least in part on the depreciation factor or the depletion factor.

23. The system of claim 21, wherein the depreciation module is further configured to compute a premium level for the insurance policy associated with the policyholder based at least in part on the ITV amount.

24. The system of claim 21 wherein the depreciation module is further configured to compute at least one of an ITV replacement cost value (RCV) amount or an ITV actual cost value (ACV) amount for the insurance policy based at least in part on the ITV amount.

25. The system of claim 24 wherein the depreciation module is further configured to compute a claim reserve requirement amount for the insurance policy based at least in part on the RCV amount or the ACV amount.

26. The system of claim 21 wherein the depletion module is configured to apply a separate depletion factor to each category of personal property, the depletion factor for a category depending on at least one of (i) the category, (ii) an amount of time since the policyholder became an adult consumer, or (iii) demographic information about the policyholder's household.

27. The system of claim 21 wherein the depreciation module is configured to apply a separate depreciation factor to each category of personal property, the depreciation factor for a category depending on at least one of (i) the category, (ii) an amount of time since the policyholder became an adult consumer, or (iii) demographic information about the policyholder's household.

28. The system of claim 21, wherein the coverage determination module is configured to compute the coverage amount based at least in part by summing across the categories of personal property spending data based on the amount of time since the policyholder became an adult consumer.

29. A method of assembling an insurance product comprising:
providing a computing device having a processor, a database accesible to the processor and a memory;
providing a memory coupled to the processor and including policyholder data for a plurality of policyholders, the policyholder data comprising, for each policyholder, categories of personal property covered by an insurance policy associated with the policyholder;
accessing, using the processor, a bulk source of consumer spending data for personal property;
segregating, using the processor, the consumer spending data for each policyholder based at least in part on the categories of personal property;
computing, using the processor, a coverage amount for each policyholder based at least in part on the segregated spending data and an amount of time since the policyholder became an adult consumer; and
computing, using the processor, an insuring to value (ITV) amount for at least one category of personal property associated with the policyholder based at least in part on applying at least one of a depreciation factor or a depletion factor associated with the at least one category of personal property to the coverage amount.

30. The method of claim 29 wherein the depreciation factor is indicative of an average decrease in value of personal property over time for the at least one category of personal property.

31. The method of claim 29 wherein the depletion factor is indicative of an average property retention duration for the at least one category of personal property.

32. The method of claim 29 further comprising computing a premium level for the insurance policy associated with the policyholder based at least in part on the ITV amount.

33. The method of claim 29 further comprising computing at least one of an ITV replacement cost value (RCV) amount or an ITV actual cost value (ACV) amount for insurance policy based at least in part on the ITV amount.

34. The method of claim 33 further comprising computing a claim reserve requirement amount for the insurance policy based at least in part on applying the RCV amount or the ACV amount to a percentage factor representing an estimate of a total value of the at least one category of personal property.

35. The method of claim 29 further comprising applying a separate depletion factor to each category of personal property, the depletion factor for a category depending on at least one of (i) the category, (ii) an amount of time since the policyholder became an adult consumer, or (iii) demographic information about the policyholder's household.

36. A non-transitory computer-readable storage medium comprising a plurality of computer-readable instructions tangibly embodied on the computer-readable storage medium, which, when executed by a data processor, provide a method for assembling an insurance product, the plurality of instructions comprising:
instructions that cause the data processor to access a bulk source of consumer spending data for personal property;
instructions that cause the data processor to segregate the consumer spending data for each policyholder based at least in part on accessing categories of personal property covered by an insurance policy associated with the policyholder;
instructions that cause the data processor to compute a coverage amount for each policyholder based on the segregated spending data and an amount of time since the policyholder became an adult consumer; and
instructions that cause the data processor to compute an insuring to value (ITV) amount for at least one category of personal property associated with the policyholder based at least in part on applying at least one of a depreciation factor or a depletion factor associated with the at least one category of personal property to the coverage amount associated with the least one category of personal property.

37. The non-transitory computer-readable storage medium of claim 36 wherein the depreciation factor is indicative of an average decrease in value of personal property over time for the at least one category of personal property.

38. The non-transitory computer-readable storage medium of claim 36 wherein the depletion factor is indicative of of an average property retention duration for the at least one category of personal property.

39. The non-transitory computer-readable storage medium of claim 36 further comprising executable instructions to compute a premium level for the insurance policy associated with the policyholder based at least in part on the ITV amount.

40. The non-transitory computer-readable storage medium of claim 36 further comprising executable instructions to apply a separate depreciation factor to each category of personal property, the depreciation factor for a category depending on at least one of (i) the category, (ii) an amount of time since the policyholder became an adult consumer, or (iii) demographic information about the policyholder's household.
